(19) United States
(12) Patent Application Publication
(10) Pub. No.: US 2015/0051064 A1
(43) Pub. Date: Feb. 19, 2015

(54) POLYVINYLPYRROLIDONE (PVP) FOR ENHANCING THE ACTIVITY AND STABILITY OF PLATINUM-BASED ELECTROCATALYSTS

(71) Applicant: GEORGETOWN UNIVERSITY, Washington, DC (US)

(72) Inventor: Yu Ye Tong, Gaithersburg, MD (US)

(73) Assignee: GEORGETOWN UNIVERSITY, Washington, DC (US)

(21) Appl. No.: 14/380,301

(22) PCT Filed: Feb. 21, 2013
(86) PCT No.: PCT/US13/27003

§ 371 Date: Aug. 21, 2014

Related U.S. Application Data
(60) Provisional application No. 61/601,257, filed on Feb. 21, 2012.

(51) Int. Cl. H01M 4/86; H01M 8/10; H01M 4/92

(52) U.S. Cl. CPC H01M 4/8663; H01M 4/92; H01M 4/926; H01M 4/921; H01M 8/1011; H01M 2250/30
USPC 502/159; 429/524

(57) ABSTRACT

The electrocatalytic compositions of this invention comprise a platinum-based electrocatalyst and polyvinylpyrrolidone (PVP), whereby the PVP improves certain properties of the platinum-based electrocatalyst. The electrolytic compositions described herein have applications in fuel cell technologies. The polymer-modified platinum-based electrocatalyst compositions exhibit an enhanced long-term CO tolerance with a small hindrance to the intrinsic activity of the platinum based electrocatalyst. Furthermore, the electrocatalytic compositions demonstrate improved catalyst stability.

### CROSS REFERENCE TO RELATED APPLICATIONS

This application claims the benefit of priority of U.S. Provisional Application No. 61/601,257, filed Feb. 21, 2012.

### STATEMENT OF GOVERNMENT INTEREST

This invention was made in part with government support under grant number CHE-0923910, awarded by the National Science Foundation. The government has certain rights to this invention.

### INCORPORATION BY REFERENCE

The documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### FIELD OF THE INVENTION

This invention relates to electrocatalytic compositions and uses thereof. The electrocatalytic compositions of this invention comprise a platinum-based electrocatalyst and polyvinylpyrrolidone (PVP), whereby the PVP improves certain properties of the platinum-based electrocatalyst.

### BACKGROUND OF THE INVENTION

The ongoing need for more efficient power sources has generated strong interest in fuel cell research. As opposed to batteries, fuel cells are energy conversion devices in which electrodes are supplied with a continuous feed supply of both fuel and oxidant, resulting in their conversion into electrochemical energy. Fuel cells are efficient and have little to no emissions.

Hydrogen gas has been studied as the fuel supply for fuel cells. However, the inherent safety, handling and storage problems associated therewith present significant drawbacks. As a result, alternative fuel sources such as alcohols and formic acid are being explored. For example, alcohol can be fed directly into the cell and undergo oxidation at the anode while oxygen is reduced at the cathode.

Among the alcohols, methanol (MeOH) has been studied in direct methanol fuel cells (DMFCs), which are potentially useful for many portable power applications and micro power applications such as, laptop computers, cell phones, etc. As a result, DMFCs have been an area of intense research directed toward alternative sources of energy.

As a liquid, methanol can integrate effectively with many applications of DMFCs, including transmission and distribution systems that currently exist. As a fuel, methanol is advantageous in terms of also being readily available from renewable sources of biomass, such as wood. Thus, the incorporation of DMFCs as alternative energy sources in many systems would reduce reliance on more commonly used energy sources such as oil and natural gas, rendering DMFCs of considerable interest as a green technology. While having advantageous properties, methanol presents significant challenges in its application to the catalytic reactions necessary for use in DMFCs. Specifically, many catalysts have insufficient activity to completely oxidize MeOH, resulting in by-products of intermediate oxidation such as aldehydes and acids.

Platinum (Pt) has long been used as the major component of anode electrocatalysts for electro-oxidation (EO) in DMFCs (J. Appl. Electrochem., 1992, 22, 1-7). Platinum-based electrocatalysts are often used as nanoparticles (NPs), which offer large surface area to volume ratios. NPs allow for more economical use of expensive noble metals for surface catalyzed fuel cell reactions. However, obstacles still exist that prevent large scale practical applications of the DMFC. One obstacle is the carbon monoxide (CO) poisoning of the catalyst during the EO of MeOH, which quickly lowers the catalytic activity of Pt (A. Hamnett, Catal. Today, 1997, 38, 445-457). Another obstacle is that at higher oxidation potentials, e.g., above about 1.2 V versus reversible hydrogen electrode, the surface platinum is oxidized, and thus it is susceptible to dissolution (Electrochimica Acta 52 (2007) 2328-2336). This leads to unstable catalysts.

Numerous efforts have been made both to improve the CO tolerance and to reduce Pt loading (Langmuir, 2003, 19, 6759-6769; Phys. Chem. Chem. Phys., 2007, 9, 5476). It has recently been discovered that the presence of 55,000 g·mol⁻¹ PVP on the surface of platinum on carbon nanoparticles can improve both the EO activity and the CO-poisoning tolerance of these systems (Phys. Chem Chem. Phys., 2011, 13, 7467-7474). Although this approach is promising towards improving certain properties of platinum-based catalyst, it does not address the issue of catalyst instability.

Citation or identification of any document in this application is not an admission that such document is available as prior art to the present invention.

### SUMMARY OF THE INVENTION

Platinum-based electrocatalyst compositions have been developed, which have improved characteristics over existing platinum-based electrocatalyst compositions. The electrocatalytic compositions contemplated in this invention comprise high molecular weight PVP on platinum-based electrocatalysts, wherein the PVP can be tuned to desorb and adsorb from the catalytic surface at varying oxidation potentials. Advantageous properties exhibited by these electrocatalyst compositions may include, without limitation, one or more of the following characteristics: improved intrinsic activity, improved carbon monoxide (CO) tolerance, and improved stability of the platinum-based catalyst surface compared to platinum-based electrocatalysts alone.

The present invention contemplates electrocatalytic compositions comprising a platinum-based electrocatalyst and high molecular weight PVP. The present invention also includes fuel cell compositions with electrocatalytic compositions comprising a platinum-based electrocatalyst and high molecular weight PVP.

The present invention also contemplates methods of improving the CO tolerance of platinum-based electrocatalyst by the use of high molecular weight PVP in the catalyst composition. Further provided, are methods of improving the stability of a platinum-based electrocatalyst by the use of high molecular weight PVP in the catalyst composition. For example, a platinum-based electrocatalyst's stability may be enhanced by preventing the oxidation of the catalyst surface. Further, a platinum-based electrocatalyst's stability may be enhanced by preventing the dissolution of the catalyst surface.

In certain embodiments, the high molecular weight PVP may improve the intrinsic activity of platinum-based electrocatalysts. In other embodiments, the high molecular weight PVP may only cause a small hindrance to the intrinsic activity of the platinum-based electrocatalyst, while improving other catalyst properties, including without limitation, CO tolerance and catalyst stability.

As described herein, high molecular weight PVP may have an average molecular weight of about 60,000 g·mol⁻¹ to about 1,600,000 g·mol⁻¹. In some embodiments, high molecular weight PVP may be PVP that has an average molecular weight of at least about 100,000 g·mol⁻¹ to about to about 1,600,000 g·mol⁻¹. In certain embodiments, the high molecular weight PVP has an average molecular weight of at least about 130,000 g·mol⁻¹ to about 1,600,000 g·mol⁻¹. In certain embodiments, the high molecular weight PVP has an average molecular weight of about 130,000 g·mol⁻¹. In other embodiments, the high molecular weight PVP has an average molecular weight of at least about 160,000 g·mol⁻¹ to about 1,600,000 g·mol⁻¹. In another embodiment, the high molecular weight PVP has an average molecular weight of about 160,000 g·mol⁻¹. In another embodiment, the high molecular weight PVP has an average molecular weight of at least 360,000 g·mol⁻¹ to about 1,600,000 g·mol⁻¹. In another embodiment, the high molecular weight PVP has an average molecular weight of about 360,000 g·mol⁻¹. In another embodiment, the high molecular weight PVP has an average molecular weight of at least about 1,300,000 g·mol⁻¹ to about 1,600,000 g·mol⁻¹. In yet another embodiment, the high molecular weight PVP has an average molecular weight of at least about 150,000 g·mol⁻¹ to about 500,000 g·mol⁻¹; 200,000 g·mol⁻¹ to about 450,000 g·mol⁻¹; or about 300,000 g·mol⁻¹ to about 400,000 g·mol⁻¹.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1: Normal CVs in 0.5M H₂SO₄ (A) and MOR CVs in 0.5M H₂SO₄+0.5M CH₃OH (B) of Pt/C (solid), PVP55-Pt/C (dot) and PVP360-Pt/C (dash) at 0.05V/s scan rate. Inset of A shows the gaseous CO oxidation curves, while inset of B displays the CA measurements performed at 0.36V vs RHE for 1800s.

FIG. 2: The potential difference spectra of Pt/C (A, D), PVP55-Pt/C (B, E) and PVP360-Pt/C (C, F) in 0.5M H₂SO₄ during the oxidation of adsorbed gaseous CO with the reference taken at 1.46V (A-C) and 0.06V (D-F). The spectral ranges are indicated for CO adsorbed as atop, bridged, hollow and multi-bound modes, which are designated as CO_{L}, CO_{B}, CO_{H} and CO_{M}, respectively. The bands attributed to the carbonyl moiety of PVP, >C═O, the bending mode of water, δ(HOH), and adsorbed (bi)sulfate anions (HSO₄⁻) are labeled.

FIG. 3: The potential difference spectra of Pt/C (A, D), PVP55-Pt/C (B, E) and PVP360-Pt/C (C, F) in 0.5M H₂SO₄+0.5M CH₃OH during the methanol oxidation with the reference taken at 1.46V (A-C) and 0.06V (D-F). The spectral ranges are indicated for CO adsorbed as atop and bridged, which are designated as CO_{L} and CO_{B}, respectively. The bands attributed to the carbonyl moiety of PVP, >C═O, the bending mode of water, δ(HOH), and adsorbed (bi)sulfate anions (HSO₄⁻) are labeled.

FIG. 4: The normalized integrated areas as a function of applied potential and the corresponding Stark tuning plots with tuning rates for linear CO (A, B) and bridged CO (C, D) in 0.5M H₂SO₄ during the gaseous CO oxidation and for methanolic-linear CO (E, F) in 0.5M H₂SO₄+CH₃OH during the methanol oxidation for Pt/C (circle) PVP55-Pt/C (square) and PVP360-Pt/C (triangle).

FIG. 5: The normalized integrated areas as a function of applied potential for the bending water mode (δHOH) (triangle), linearly bound CO, CO_{L} (circle) and the carbonyl moiety of PVP, >C═O (square), on Pt/C (A, D), PVP55-Pt/C (B, E) and PVP360-Pt/C (C, F) in 0.5M H₂SO₄ during the gaseous CO oxidation (A-B) and in 0.5M H₂SO₄+CH₃OH during the methanol oxidation (D-F).

FIG. 6: TGA curves of as-synthesized PVP55-Pt/C (dot) and PVP360-Pt/C (blue-dash) with 440-450° C. loss attributed to PVP. Inset shows the TGA curve following NaOH-treatment.

FIG. 7: A schematic of the ATR-SEIRAS apparatus.

FIG. 8: Onset potential normalized anodic scan of the MOR of Pt/C (solid), PVP55-Pt/C (dot) and PVP360-Pt/C (dash) in 0.5M H₂SO₄+0.5M CH₃OH.

FIG. 9: Example of Deconvolution for CO adsorbed in bridged and hollow modes, which are designated CO_{B} and CO_{H} of the potential difference spectra of Pt/C (A), PVP55-Pt/C (B) and PVP360-Pt/C (C) in 0.5M H₂SO₄ during the oxidation of adsorbed gaseous CO at 0.5V potential with the reference taken at 1.46V.

### DETAILED DESCRIPTION

Polymer modified platinum-based electrocatalyst compositions, which exhibit advantageous properties, such as, enhanced long term CO tolerance and improved catalyst stability have been developed. One polymer used for this modification is PVP. By improving certain characteristics of the platinum-based electrocatalyst, the PVP polymer can potentially improve the performance and application of platinum-based electrocatalysts in fuel cells. A particular fuel cell of interest is the direct methanol fuel cell (DMFC). Surprisingly, the improved electrocatalyst characteristics of enhanced CO tolerance and improved stability may also be affected by certain physical characteristics of the PVP, for example, molecular weight.

Physical characteristics of the PVP used in electrocatalyst compositions of this invention, such as molecular weight, affect how the polymer behaves on the surface of the catalyst. For example, the molecular weight of the PVP may affect how and at what oxidation potential the polymer adsorbs and desorbs from the catalyst surface. Understanding the effects of adsorbed PVP on platinum-based electrocatalysts is of fundamental and of practical importance, due to platinum's widespread use for fuel cell applications.

PVP is known to interact with metal surfaces chiefly through its carbonyl, >C═O, moiety of the polymer that is detectable in the IR region. The effects of high molecular weight PVPs were probed using electrochemical methods to determine their electrocatalytic effects in EO reactions. In situ surface enhanced IR absorption spectroscopy (SEIRAS) experiments was one method used to interrogate the polymer's mechanistic behavior under the prescribed reaction conditions.

Electrochemical experiments have demonstrated the ability of PVP to affect the surface conditions, thereby, the EO reaction itself. Surprisingly, the polymer adsorption does not render the electrocatalyst inactive for methanol oxidation reactions (MORs). Without being bound by theory, it appears that the enhanced CO tolerance and rapid current output in the low potential region in MOR cyclic voltamogram (CV) curves by the PVP-modified platinum-based electrocatalyst samples suggest that the reactive species on the Pt electrocatalyst surface is being altered by the surface-bound polymer. Certain species of high molecular weight PVP appear to desorb from the Pt electrocatalyst surface in the functional potential range of a methanol fuel cell. The potential range in which desorption of the polymer is observed also correlates with increased water adsorption. It has also been observed that high molecular weight PVP re-adsorbs on the Pt electrocatalyst surface at higher oxidation potentials. The range of potentials in which PVP re-adsorption occurs corresponds to the potential range that the surface platinum is oxidized, and thus becomes susceptible of dissolution, i.e., becomes unstable.

A difference between lower weight PVPs and higher weight PVPs is that the former does not show a readsorption of >C═O at high potential, but the latter did. This finding, as described. in more detail below, indicates that high molecular weight PVP can behave as a molecular switch; desorbing at potentials that are needed for fuel cell function and re-adsorbing at potentials that can damage the Pt electrocatalyst. Specifically, a potential utility of this invention is to use this observed molecular switch functionality to enhance the methanol oxidization via increased water adsorption and more available surface sites freed by >C═O desorption and to stabilize the Pt by the >C═O re-adsorption that prevents Pt dissolution.

At low potentials, including but not limited to the functional potential range of a methanol fuel cell, the PVP polymer will desorb from the surface of the platinum-based electrocatalyst. However, at higher potentials the PVP will re-adsorb onto the surface of the platinum-based electrocatalyst. The re-adsorption of the PVP onto the catalyst surface may prevent the platinum-based electrocatalyst from oxidizing at high oxidation potentials. The oxidation of the platinum surface can lead to dissolution of the catalyst surface. Therefore, by preventing the oxidation of the platinum-based electrocatalyst surface, the PVP improves the stability of the catalyst and prevents dissolution.

In certain embodiments, the PVP desorbs from the surface of the platinum based electrocatalyst such that a DMFC may function with small hindrance to the intrinsic activity of the platinum electrocatalyst. In some embodiments, there is a decrease in peak current of about 0-50%; about 0-40%; about 0-30%; about 0-20%; or about 0-10%. In other embodiments, the decrease in peak current is about 1-20%; about 20-40%; or about 40-60%. In certain embodiments, there is an increase in peak current.

In certain embodiments, the PVP desorbs from the platinum electrocatalyst surface in the functional range of the methanol fuel cell. In specific embodiments, the PVP desorbs from the platinum electrocatalyst surface in a potential range selected from about 0.0 V-1.0 V; about 0.0 V-0.90 V; about 0.0 V-0.80 V; about 0.01 V-1.0 V; about 0.01 V-0.90 V; about 0.01 V-0.80 V; about 0.02 V-1.0 V; about 0.02 V-0.90 V; about 0.02 V-0.80 V; about 0.03 V- 1.0 V; about 0.03 V-0.90 V; and about 0.03 V-0.80 V versus reversible hydrogen electrode (RHE).

In certain embodiments, the PVP re-adsorbs onto the surface of the platinum-based electrocatalyst beginning at potentials of at least about 0.60 V; 0.65 V; 0.70 V; 0.85 V; 0.90 V; 1.0 V; 1.1 V; 1.2 V; 1.3 V; 1.4 V; 1.5 V; or 1.6 V vs RHE. In certain embodiments, PVP re-adsorbs onto the platinum-based electrocatalyst surface in a range of potentials selected from about 0.60-1.6 V; 0.70-1.6 V; 0.80-1.6 V; 0.85-1.6 V; 0.90-1.6 V; 1.0-1.6 V; 1.1-1.6 V; 1.2-1.6 V; 1.3-1.6 V; 1.4-1.6 A; and 1.5-1.6 V vs RHE. In a specific embodiment, the PVP is adsorbed on the Pt electrocatalyst surface when the reaction potential is at the oxidation potential of platinum, i.e., about 1.2 V vs RHE, in an amount sufficient to prevent or reduce the oxidation of the platinum catalyst surface.

The present invention includes an electrocatalytic composition comprising a platinum-based electrocatalyst and high molecular weight polyvinylpyrrolidone (PVP). As described herein, high molecular weight PIN may have an average molecular weight of about 60,000 g·mol⁻¹ to about 1,600,000 g·mol⁻¹. In some embodiments, high molecular weight PVP may be PVP that has an average molecular weight of at least about 100,000 g·mol^{—1} to about to about 1,600,000 g·mol⁻¹. In certain embodiments, the high molecular weight PVP has an average molecular weight of at least about 130,000 g·mol⁻¹ to about 1,600,000 g·mol⁻¹. In certain embodiments, the high molecular weight PVP has an average molecular weight of about 130,000 g·mol⁻¹. In other embodiments, the high molecular weight PVP has an average molecular weight of at least about 160,000 g·mol⁻¹ to about 1,600,000 g·mol⁻¹. In another embodiment, the high molecular weight PVP has an average molecular weight of about 160,000 g·mol⁻¹. In another embodiment, the high molecular weight PVP has an average molecular weight of at least 360,000 g·mol⁻¹ to about 1,600,000 g·mol⁻¹. In another embodiment, the high molecular weight PVP has an average molecular weight of about 360,000 g·mol⁻¹. In another embodiment, the high molecular weight PVP has an average molecular weight of at least about 1,300,000 g·mol⁻¹ to about 1,600,000 g·mol⁻¹. In yet another embodiment, the high molecular weight PVP has an average molecular weight of at least about 150,000 g·mol⁻¹ to about 500,000 g·mol⁻¹; 200,000 g·mol⁻¹ to about 450,000 g·mol⁻¹; or about 300,000 g·mol⁻¹ to about 400,000 g·mol⁻¹.

In certain embodiments, the amount of PVP coverage in the PVP/Pt electrocatalyst composition is about 1-20 wt % PVP/Pt; 5-20 wt % PVP/Pt; 1-15% PVP/Pt; 5-15% PVP/Pt; 1-10% PVP/Pt or 5-10% PVP/Pt.

In some embodiments, the platinum-based electrocatalyst of the electrocatalytic composition may be platinum on activated carbon Pt/C. In certain embodiments, the Pt/C electrocatalyst may be about 1-70 wt % Pt; 3-60 wt % Pt; 5-60 wt % Pt; 10-60 wt % Pt; 20-60 wt % Pt; or 30-50 wt % Pt. In certain embodiments, the Pt/C electrocatalyst may be about 3 wt % Pt; 5 wt % Pt; 10 wt % Pt; 20 wt % Pt; 30 wt % Pt; 40 wt % Pt; 50 wt % Pt; or 60 wt % Pt.

In some embodiments, the platinum-based electrocatalyst of the electrocatalytic composition may be a platinum alloy. In certain embodiments, the platinum alloy is a transition metal alloy.

In some embodiments, the platinum-based electrocatalyst of the electrocatalytic composition is an adlayered platinum on a transition metal. In certain embodiments, the electrocatalyst is platinum adlayered on ruthenium. In specific embodiments, the platinum is adlayered on ruthenium nanoparticles as described in U.S. Publication No. 2011/0256469, which is incorporated herein by reference.

In certain embodiments, the platinum-based electrocatalyst of the composition is in nanoparticulate form. Nanoparticles of the present invention have a physical dimension of about 1 nm to about 250 nm; about 1 nm to about 100 nm; about 1 nm to about 50 nm; about 1 nm to about 25 nm; or about 1 nm to about 10 nm. Methods of determining the physical dimensions of electrocatalyst nanoparticles are known to those of skill in the art.

The present invention also contemplates a direct methanol fuel cell (DMFC) comprising a platinum-based electrocatalyst and high molecular weight polyvinylpyrrolidone (PVP) composition.

In some embodiments, the amount of PVP coverage in the PVP/Pt electrocatalyst of the DMFC is about 1-20 wt % PVP/Pt; 5-20 wt % PVP/Pt; 1-15% PVP/Pt; 5-15% PVP/Pt; 1-10% PVP/Pt or 5-10% PVP/Pt.

In some embodiments, the platinum-based electrocatalyst of the DMFC may be platinum on activated carbon Pt/C. In certain embodiments, the Pt/C electrocatalyst may be about 1-70 wt % Pt; 3-60 wt % Pt; 5-60 wt % Pt; 10-60 wt % Pt; 20-60 wt % Pt or 30-50 wt % Pt. In certain embodiments, the Pt/C electrocatalyst may be about 3 wt % Pt; 5 wt % Pt; 10 wt % Pt; 20 wt % Pt; 30 wt % Pt; 40 wt % Pt; 50 wt % Pt; or 60 wt % Pt.

In some embodiments, the platinum-based electrocatalyst of the DMFC may be a platinum alloy. In certain embodiments, the platinum alloy is a transition metal alloy.

In some embodiments, the platinum-based electrocatalyst of the DMFC is an adlayered platinum on a transition metal. In certain embodiments, the electrocatalyst is platinum adlayered on ruthenium. In specific embodiments, the platinum is adlayered on ruthenium nanoparticles as described in U.S. Publication No. 2011/0256469, which is incorporated herein by reference.

In certain embodiments, the platinum-based electrocatalyst of the DMFC is in nanoparticulate form.

Also contemplated herein, is a method of conducting methanol electro-oxidation with a platinum-based electrocatalyst while preventing the oxidation of the platinum-based electrocatalyst's surface, wherein the method comprises combining the platinum-based electrocatalyst with high molecular weight PVP.

In some embodiments, the amount of PVP coverage in the PVP/Pt electrocatalyst of the method is about 1-20 wt % PVP/Pt; 5-20 wt % PVP/Pt; 1-15% PVP/Pt; 5-15% PVP/Pt; 1-10% PVP/Pt or 5-10% PVP/Pt.

In some embodiments, the platinum-based electrocatalyst of the method may be platinum on activated carbon Pt/C. In certain embodiments, the Pt/C electrocatalyst may be about 1-70 wt % Pt; 3-60 wt % Pt; 5-60 wt % Pt; 10-60 wt % Pt; 20-60 wt % Pt; or 30-50 wt % Pt. In certain embodiments, the Pt/C electrocatalyst may be about 3 wt % Pt; 5 wt % Pt; 10 wt % Pt; 20 wt % Pt; 30 wt % Pt; 40 wt % Pt; 50 wt % Pt; or 60 wt % Pt.

In some embodiments, the platinum-based electrocatalyst of the method may be a platinum alloy. In certain embodiments, the platinum alloy is a transition metal alloy.

In some embodiments, the platinum-based electrocatalyst of the method is an adlayered platinum on a transition metal. In certain embodiments, the platinum-based electrocatalyst is platinum adlayered on ruthenium. In specific embodiments, the platinum is adlayered on ruthenium nanoparticles as described in U.S. Publication No. 2011/0256469, which is incorporated herein by reference.

In certain embodiments, the platinum-based electrocatalyst of the method is in nanoparticulate form.

Also contemplated herein, is a method of conducting methanol electro-oxidation with a platinum-based electrocatalyst while improving the CO tolerance of the platinum-based electrocatalyst, wherein the method comprises combining the platinum-based electrocatalyst with high molecular weight PVP.

In some embodiments, the amount of PVP coverage in the PVP/Pt electrocatalyst of the method is about 1-20 wt % PVP/Pt; 5-20 wt % PVP/Pt; 1-15% PVP/Pt; 5-15% PVP/Pt; 1-10% PVP/Pt or 5-10% PVP/Pt.

In snme emhndiments, p atinum-bnsed electrocatalyst of the methnd may be platinum on activated carbon Pt/C. In certain embodiments, the Pt/C electrocatalyst may be about 1-70 wt % Pt; 3-60 wt % Pt; 5-60 wt % Pt; 10-60 wt % Pt; 20-60 wt % Pt; or 30-50 wt % Pt. In certain embodiments, the Pt/C electrocatalyst may be about 3 wt % Pt; 5 wt % Pt; 10 wt % Pt; 20 wt % Pt; 30 wt % Pt; 40 wt % Pt; 50 wt % Pt; or 60 wt % Pt.

### EXAMPLES

### Example 1

### Electrocatalyst Preparation

The commercial platinum-based electrocatalyst was carbon-supported Pt at 40 wt % metal loading (Pt/C, courtesy of Johnson-Matthey). The Pt/C was used in the as-received state without further modification, prior to the electrochemical studies and the PVP protection process with PVP with molecular weights of 55,000 g·mol⁻¹ (PVP55) or 360,000 g·mol⁻¹ (PVP360). PVP-protected Pt/C samples were prepared using a modified one-step procedure according to an established polyol based process (Song et al., J. Phys. Chem. B. 109 (2004) 188-193).

In brief, 2.5 mL of ethylene glycol (EG) was boiled and refluxed for 5 min before the addition of 0.375 M PVP (3 mL total) and 0.0675M Pt (1.5 mL total) in 40 wt % Pt/C to the refluxing solution, which was then refluxed for 1 hr. The purification process included repetitive centrifugation and precipitation in a 3:1 volume mixture of mixed hexanes:ethanol, where the resultant PVP-modified Pt/C was dispersed into ultra-pure Milli-Q (18.2 MΩ) water. The PVP360-Pt/C sample underwent an additional purification process because the as-prepared sample was poorly electrochemically active. The additional purification process entailed an overnight soak in concentrated NaOH before final dispersion in 18.2 MΩ water.

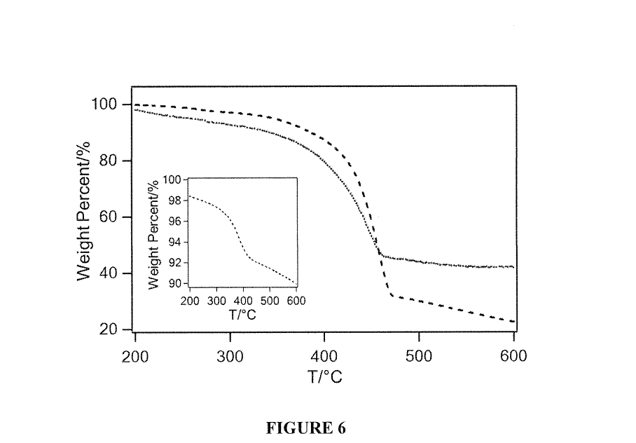

Thermogravimetric Analysis (TGA) experiments were performed by a TA Instruments SDTQ600 model and analyzed by a computer with Universal TA Analysis 2000 software to determine the polymer coverage of ca. 50 and 60 wt % of polymer on as-synthesized PVP55-Pt/C and PVP360-Pt/C, respectively. The NaOH-treated PVP360, which was used for these experiments, was roughly 6 % wt of PVP360 (See FIG. 6). The TGA experiments began at room temperature and increased to 800° C. at a rate of 10° C./min with a steady flow of nitrogen.

### Example 2

### Electrochemical Measurements

The electrochemical measurements were performed in an Ar-blanketed conventional three-electrode electrochemical cell using a CHI 760c potentiostat (CH Instrument, Inc) that was controlled by a computer with CHI software. The cyclic voltammograms (CVs) were recorded with a 50 mV/s scan rate. The electrode potentials herein are given in reference to the RHE, though physically measured with Ag/AgCl (3M) reference electrode (0.26V with respect to RHE in 0.5M H₂SO₄). The currents reported are normalized with respect to the Pt surface area, which was determined by the hydrogen desorption charge per area, 220 μC/cm² (B. E. Conway, G. Jerkiewicz, J. Electroanal. Chem. 339 (1992) 123-146). Commercial Ag/AgCl (3M; CH Instrument, Inc) and Pt gauze electrodes were used as the reference and counter electrodes, respectively. The working electrode was comprised of a well-polished 3 mm commercial glassy carbon electrode (GCE) (BASi) that had catalysts deposited onto it. The catalyst deposition involved a dilute suspension of NPs in water that was drop cast onto the GCE and allowed to air dry. The supporting electrolyte solution, 0.5M H2SO4, was prepared with milli-Q water (18.2 MΩ). Carbon monoxide (CO) oxidations were performed by adsorbing ultrahigh purity CO gas for 300 s subsequently 900 s of Ar purging to remove excess CO from the electrolyte, with the potential held constant at 0.36V vs RHE in 0.5M H₂SO₄, respectively. The MOR was carried out in 0.5M H₂SO₄+0.5M CH₃OH with the potential held at 0.36V for 300 s before the electrochemical measurement. The chronoamperometric (CA) measurements were collected for 1800 s at a constant potential of 0.36V vs RHE in 0.5M H₂SO₄+0.5M CH₃OH.

### Example 3

### ATR-SEIRAS Measurements

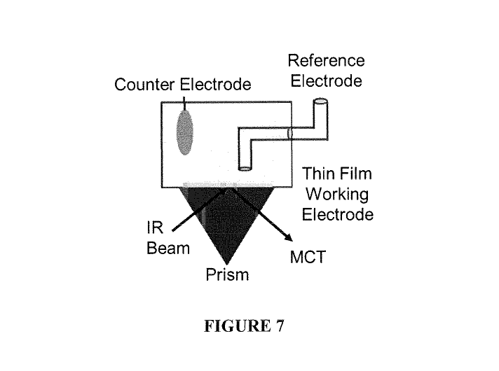

The SEIRAS measurements were collected on a Bruker Vector-22 Infrared Spectrometer equipped with a liquid-nitrogen-cooled mercury-cadmium-telluride (MCT) detector that was modified to house an EC-IR cell and an optical reflection accessory with an incident angle of >60° for total attenuation reflection. The obtained spectra are shown in the absorbance units defined as −log (I/I₀) where I and I₀ are the singe-beam spectral intensities at the measuring potential and the reference potential, respectively. The spectra were collected during a potential step experiment with a 0.05V step size and 100 scans taken at each step with 4 cm⁻¹ spectral resolution. The in-situ electrochemical measurements were performed in an Ar-purged three electrode electrochemical cell using an EG&G 273A potentiostat (Princeton Applied Research)/CHI that was controlled by a computer with CoreWare (Scribner)/CHI software. Commercial Ag/AgCl (3M) (CH Instrument, Inc) and Pt gauze electrodes were used as the reference and counter electrodes, respectively. The working electrode was comprised of a well polished triangular Si prism that had a thin Au film chemically deposited onto the surface as shown in FIG. 7 (H. Miyake, S. Ye, M. Osawa, Electrochem. Comm. 4 (2002) 973-977). The catalysts were deposited directly onto the Au film as an aqueous 100 μL droplet, which was allowed to air dry. The catalysts on the Au film were monitored between IR scan-potential step experiments via CV in order to ensure that the system was stable using the identical procedures as in the electrochemical experiments. The CV and CO spectra were performed in 0.5M H₂SO₄ and the MOR was performed in 0.5M H₂SO₄+0.5M CH₃OH with the stair measurements conducted in the potential range of 0.01-41.46V vs RHE for Pt/C and PVP-modified Pt/C samples.

A. Electrochemical Characterization

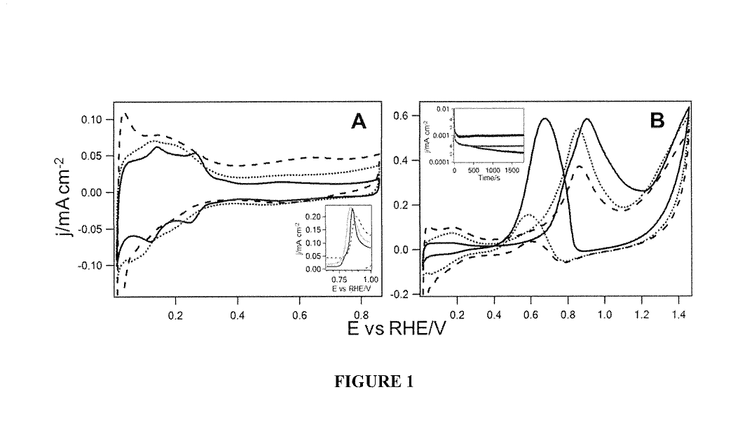

CV was used first to probe the electrochemical and electrocatalytic modifications of the commercial Pt/C following surfactant adsorption. FIG. 1A displays the CV curves for Pt/C, PVP55-Pt/C and PVP360-Pt/C recorded with a 50 mV/s scan rate in 0.5M H₂SO₄ supporting electrolyte. The Pt/C exhibited hydrogen redox peaks corresponding to 110 and 100 sites at ca. 0.13 and 0.25V, which were suppressed in the presence of the adsorbed polymer (Pietron et al., Electrochem. and Solid-State Lett. 11 (2008) B161-B165; Z.-Y; Zhou et al., Physical Chemistry Chemical Physics 14 (2012) 1412-1417; Gatewood et al., The Journal of Physical Chemistry C. 112 (2008) 4961-4970). The electrochemical surface area of the Pt NPs, which was determined by the hydrogen desorption charge per area of 220 μC/cm², was used to normalize the reported current densities and provide a basis of comparison for electrocatalytic activity (B. E. Conway, G. Jerkiewicz, J. Electroanal. Chem. 339 (1992) 123-146). The catalysts were cycled below 0.86V to minimize surface restructuring before increasing the high limiting potential for oxidation reactions.

The FIG. 1A inset shows the gaseous CO oxidation CV curves for the samples, where we assume full coverage of CO on available Pt sites. The peak potentials are 0.858, 0.843 and 0.887V for Pt/C, PVP55-Pt/C and PVP360-Pt/C, respectively. Based on this result, there is a slight improvement in COR at nearly full CO coverage with PVP55 and a decline with PVP360 compared to Pt/C. The broader widths of the CO peak for polymer-modified samples suggests an increased number of adsorption modes, which is most likely due to the polymeric chains randomly distributed across the Pt surface.

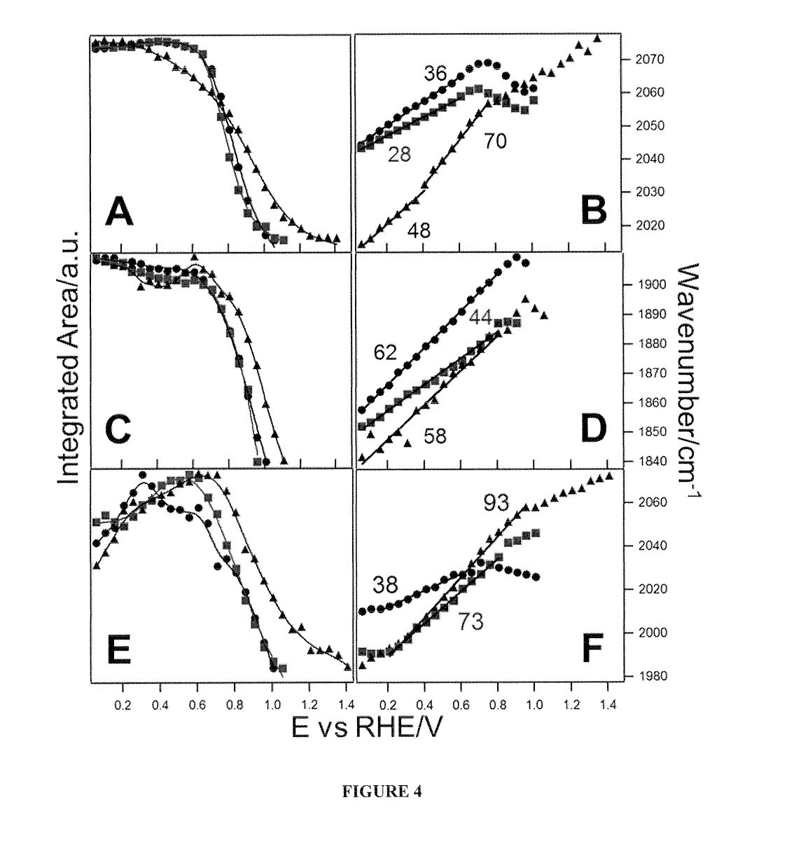

The MOR activities for the Pt/C and PVP-modified Pt/C samples are illustrated in the CVs of FIG. 1B. No effort was taken in this study to optimize the PVP coverage needed to obtain an intrinsic reaction enhancement as previously observed; therefore the commercial Pt/C provided the highest current peak density of 0.583 mA/cm² in FIG. 4B. As anticipated, the heaviest polymer, PVP360, affected the Pt/C activity the most with ca. 36% decrease in the peak current. Meanwhile, the PVP55-Pt/C lost ca. 7% of its activity relative to the pristine Pt/C.

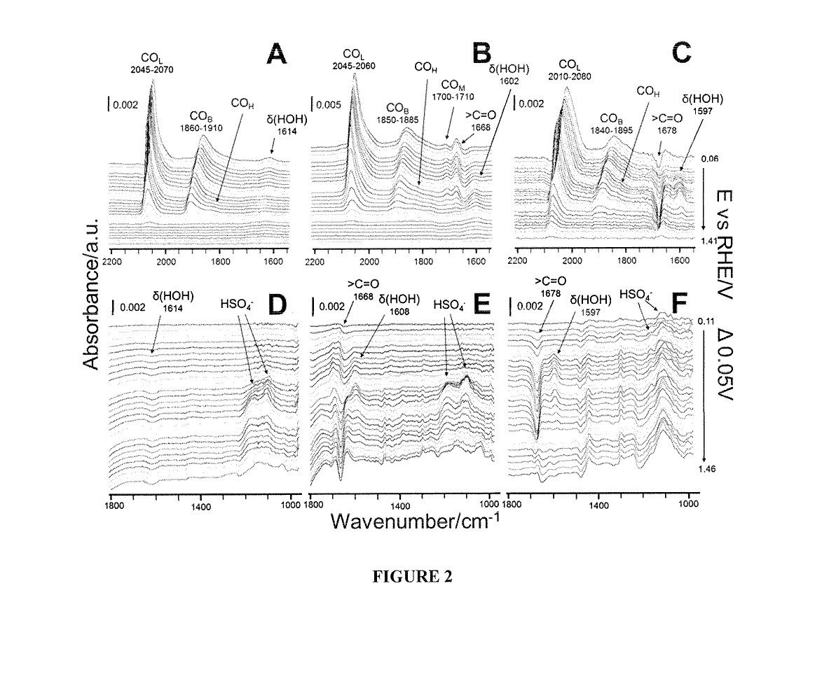

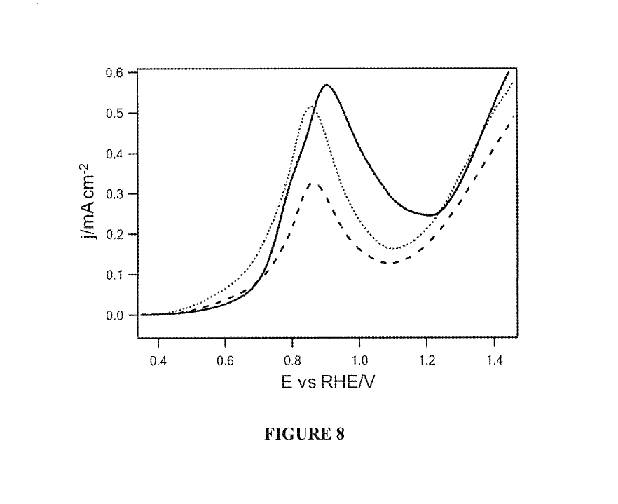

Simultaneously, the PVP-modified samples exhibited a negative potential shift of the peak from 0.905V on the Pt/C to 0.855 and 0.865V on the PVP55-Pt/C and PVP360-Pt/C, respectively. The Pt/C, PVP55-Pt/C and PVP360-Pt/C exhibited similar values for the onset potential of 0.367, 0.373 and 0.393V, respectively. The polymer-modified Pt/C, however, showed less blocked hydrogen adsorption sites and yielded the swiftest rise in current following the onset with the fastest rate on PVP55-Pt/C (FIG. 8). The latter implies the decreased production of poisonous CO. Indeed, the CA curves recorded at 0.36V as shown in the inset of FIG. 2B suggest CO tolerance improves with polymeric weight, which were performed in the onset potential region of the electrocatalysts.

The electrochemical experiments have clearly demonstrated the ability of PVP to affect the surface conditions, thereby, the reaction itself. Interestingly, the polymer adsorption does not render the electrocatalyst inactive for the MOR. The enhanced CO tolerance as seen in the CA measurements and rapid current output in the low potential region in the MOR CV curves by the PVP-modified samples compared to the Pt/C suggests that the reaction species on the Pt/C surface are being altered by the surface-bound polymer. In situ SEIRAS was therefore employed in an effort to elucidate and develop plausible explanations related to the modifications of detectable intermediates and supporting electrolyte interactions in the presence of adsorbed polymer.

B. In Situ SEIRAS Characterization

1. CO Oxidation

FIG. 2 displays the potential difference spectra for the oxidation of gaseously adsorbed CO (CO_{ads}) on the Pt/c, PVP55-Pt/C and PVP360-Pt/C during a stair-step measurement from −0.06 to 1.46V with a 0.05V step with high (A-C) and low potential references (D-F). The high referenced Pt/C spectra in FIG. 2A consist of the well-documented linearly bound CO (CO_{L}) band, whose frequency ranges from 2045-2070 cm⁻¹, and a second lesser band attributed to bridge bonded CO (CO_{B}) shows a vibrational range from 1860-1910 cm⁻¹. Additionally, the Pt/C exhibited a small hump towards the ends of the oxidation process near 1855 cm⁻¹ at 0.81V, which is associated with CO adsorbed at hollow sites, COH (FIG. 8) (Miyake et al., Phys. Chem. Chem. Phys. 10 (2008) 3662-3669). CO was oxidized from the surface as the potential increases stepwise to 1.46V with complete oxidation at ca. 1.05V.

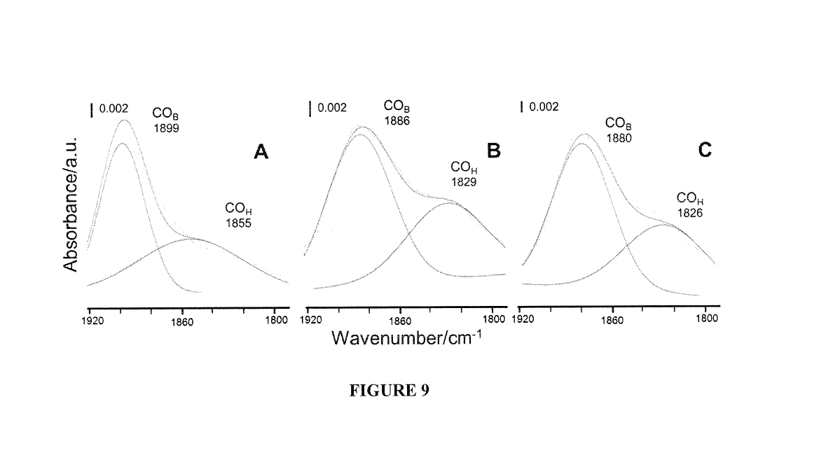

Similar adsorption modes are visible in the spectra of PVP55-Pt/C (FIG. 2B) and PVP360-Pt/C (FIG. 2C), however, their spectra is more complex due to the presence of PVP. CO_{L} provided the dominant band that ranged between 2045-2060 cm⁻¹ and 2010-2080 cm⁻¹ for the PVP55-Pt/C and PVP360-Pt/C, respectively, with the latter showing a large red-shift at potentials below 0.7V (see FIG. 4B). A red-shift was also observed for the CO_{B} band in the presence of polymer compared to the pristine Pt/C with frequency ranges from 1850-1885 cm⁻¹ and 1840-1895 cm⁻¹ with PVP55 and PVP360, respectively. The corresponding COH hump was also red-shifted ca. 30 cm⁻¹ to 1829 and 1826 cm⁻¹ at 0.5V for the PVP55-Pt/C and PVP360-Pt/C, respectively (FIG. 9). A small peak located at approximately 1700-1710 cm⁻¹ appeared on PVP55-Pt/C that we attributed to a multi-bound CO, COM (Miyake et al., Phys. Chem. Chem. Phys. 10 (2008) 3662-3669). In addition to CO_{ads}, the polymer's carbonyl, >C═O, exhibited a strong vibration centered at 1668 and 1678 cm⁻¹ for PVP55 and PVP360, respectively.

The spectra are referenced to the low potential in FIG. 2D-F, where we can observe species between 1800 and 950 cm⁻¹. PVP exhibited bands at ca. 1450 and 1300 cm⁻¹ associated with the vibrations of its several moieties, i.e., CH₃ and CH₂. (Susut et al., Electrochim. Acta. 53 (2008) 6135-6142). Two adsorption modes of the (bi)sulfate anion, HSO₄⁻, from the supporting electrolyte on each electrocatalyst were observed near 1200 and 1100 cm⁻¹, which have been identified as the three-fold and two-fold modes (Faguy et al., Electroanal. Chem. 407 (1996) 209-218). Notice that the (bi)sulfate anion band appeared much earlier on PVP360-Pt/C than on the other two samples and was dominated by the two-fold mode. More relevant for the CO oxidation is the direct observation of the bending vibrational mode of water, δ(HOH), at ca. 1614, 1602 and 1597 cm⁻¹ on the Pt/C, PVP55-Pt/C and PVP360-Pt/C, respectively. The PVP55-PVC oxidized CO completely near 1.05V in a similar fashion to the Pt/C. The COL on the PVP360-Pt/C, however, remained on the surface until the high potential limit, which is consistent with the slow decreasing current tail of the CO stripping peak in the inset of FIG. 1A. On the other hand, COB on PVP360-Pt/C was completely oxidized about 50 mV higher than COB on Pt/C and PVP55-Pt/C.

2. Methanol Oxidation

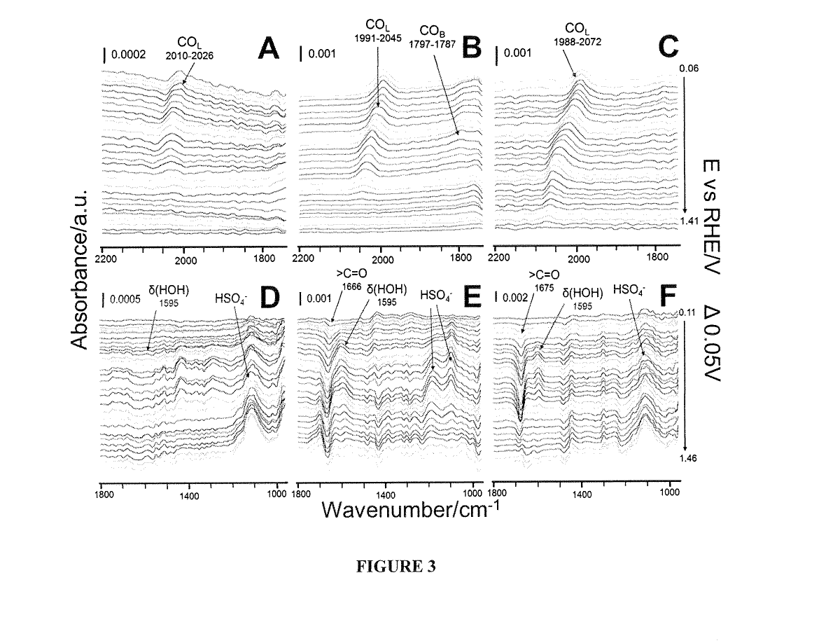

The spectra shown in FIG. 3 summarizes the oxidation of methanol on the Pt/C, PVP55-Pt/C and PVP360-Pt/C during the stair-step measurement with high (A-C) and low potential references (D-F). The high referenced Pt/C spectra in FIG. 3A displays a COL band with a frequency range from 2010-2026 cm⁻¹. The CO_{L} band was also observed in the spectra of the PVP55-Pt/C (FIG. 3B) and PVP360-Pt/C (FIG. 3C) that ranged between 1991-2045 cm⁻¹ and 1988-2072 cm⁻¹, respectively. In addition, no bridge-bound CO was observed except for PVP55-Pt/C that exhibited a small peak, most likely CO_{B}, at 1797-1787 cm⁻¹. Complete oxidation of CO_{L} occurred by ca. 1.05V on the Pt/C and PVP55-Pt/C as in the gaseously adsorbed CO oxidation and similarly COL lingered on the PVP360-Pt/C to the high potential limit.

The low referenced spectra indicate that the principal adsorption mode of HSO₄⁻ on the Pt/C and PVP360-Pt/C was the two-fold centered near 1100 cm⁻¹. It seems that CH₃OH had restricted the modes for the supporting electrolyte on the Pt/C more so than the gaseous CO at saturation. Alternatively, the three-fold and two-fold modes at ca. 1200 and 1100 cm⁻¹ were observed on the PVP55-Pt/C just as in the gaseous CO oxidation. Again, we observed δ(HOH) at ca. 1595 cm⁻¹ on each electrocatalyst. The >C═O of the PVP55-Pt/C and PVP360-Pt/C is centered at 1668 and 1678 cm⁻¹, which showed similar behavior to the >C═O during the gaseous CO oxidation. Unfortunately, similarities between plausible methanol intermediates vibrations are indistinguishable from the overlapping polymer bands in the same region as previously mentioned in the discussion of the CO oxidation.

3. Influence of PVP Molecular Weights

FIG. 4 summaries the oxidation trends of CO_{ads} on the electrocatalyst during the in situ SEIRAS measurements in terms of their normalized band areas (A, C, E) and peak positions (B, D and F) as functions of applied potential. FIG. 4A indicates the oxidation of CO_{L} began on the PVP360-Pt/C near 0.4V, whereas the oxidation on the other two samples was delayed ca. 0.2V. Although, the oxidation onset was first achieved with PVP360, the reaction was incomplete until 1.41V, well beyond the 1.1V potential for complete oxidation on Pt/C and PVP55-Pt/C. The vibrational frequency dependence on the applied electric field, commonly referred to as the Stark tuning effect, for each sample is plotted in FIG. 4B. The tuning rates of 36 and 28 cm-1/V are reasonable values for the Pt/C and PVP55-Pt/C given their CO_{L} oxidation similarities (Kunimatsu et al., Langmuir. 24 (2008) 3590-3601). In contrast, the PVP360-Pt/C exhibits dual tuning rates below ea. 0.8V. The initial rate of 48 cm⁻¹/V changes drastically near 0.4V to a slope of 70 cm⁻¹/V that coincides with the onset for CO_{L} oxidation. Moreover, we observe a decrease (red-shift) of the COL vibration on both the PVP55-Pt/C and Pt/C coincident with the onset of major CO_{R} on these two samples, but the vibration continued to increase (blue-shift) on PVP360-Pt/C.

The corresponding CO_{B} band areas in FIG. 4C, also highlights the disparity among the three samples. There were small band area variations at potentials <0.6V likely due to nonoxidative local adsorbate reorganization because no changes in Stark tuning rates were observed in FIG. 4D. The main oxidation occurred beyond 0.6V with the Pt/C and PVP55-Pt/C following the same COR pattern that began ca. 50 mV sooner than that of the PVP360-Pt/C. The COR on the Pt/C and PVP55-Pt/C was completed near 1.0V, while PVP360-Pt/C near 1.1V. FIG. 4D displays the Stark plots for COB, which clearly demonstrates decreased vibrational frequency as polymer Mw increased. I interestingly, the PVP360-Pt/C and Pt/C share similar tuning rates of ca. 60 cm-1/V, but the PVP55-Pt/C shows a lower rate of 44 cm-1/V. Each electrocatalyst showed an immediate red-shift of COB frequency near 0.85V at which the major COR occurred, which was not observed for CO_{L} on the PVP360-Pt/C.

Alternatively, FIG. 4 also recapitulates the methanolic-CO_{L} on the samples to emphasis the different trends from the saturated CO coverage discussed above. As shown in FIG. 4E, CO bands appeared on all three samples at the lowest potential, which indicates that they were all quite active towards dissociatively adsorbed methanol in an order PVP55>Pt/C>PVP360. The amount of methanolic-CO increased incrementally as potential shifted positively until reaching the potential at which the generated CO began oxidation. Although the onset potential of CO_{R} for methanolic-CO on the Pt/C was as low as 0.3V, the initial CO_{R} was relatively slow until it joined the descending curve of the PVP55-Pt/C at en. 0.7V whose onset potential was at 0.6V.

The most positive onset potential for COR of methanolic-CO, 0.65V, was observed on the PVP360-Pt/C, similar to that of CO_{B}. It is clear from the plot that the methanolic-CO_{L} on the PVP360-Pt/C also remained on the surface until the high potential just as with gaseous CO_{L}. The Stark plots in FIG. 4F shows that the vibrational frequencies red-shifted, which was probably due to lower CO coverage that led to weaker dipole-dipole interaction among CO_{ads}Interestingly, the PVP55 and PVP360 shared very high tuning rates of 73 and 93 cm⁻¹/V, respectively, which was nearly double the value obtained for the clean Pt/C. Moreover, there is no evidence of a sudden red-shift of the CO_{ads} frequency in the presence of a polymer chain, suggesting that the COR of methanolic-CO might proceed along the peripheries of CO islands, however, the PVP360 exerted a stronger influence on the vibrational shift.

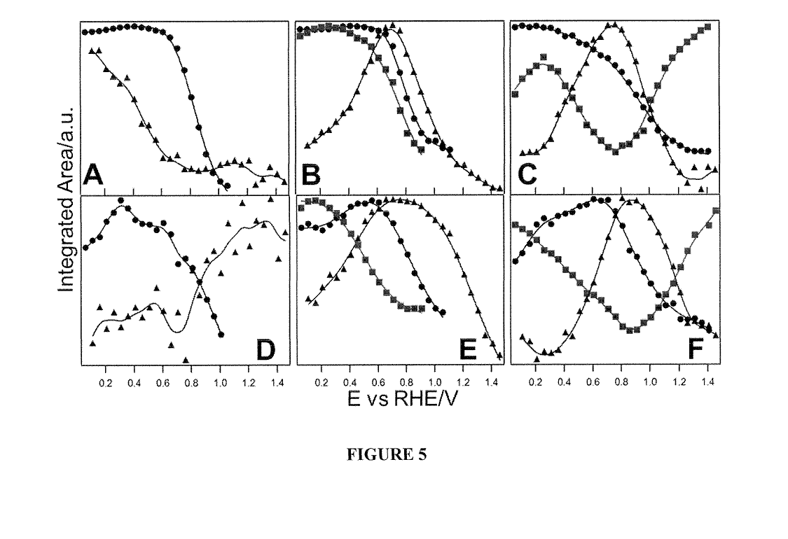

In an effort to elucidate the direct effect of PVP on surface species, the normalized band integrals of CO_{L}, δ(HOH) and >C═O on individual electrocatalysts were plotted as a function of applied potential and shown in FIG. 5. As noted in the spectral analysis, the major difference between the pristine (FIG. 5A) and polymer-modified (FIGS. 5B and C) Pt/C was the appearance of a >C═O stretching mode. Interestingly, the >C═O moiety behaves similar to CO_{ads} and seems to experience an oxidation-like process with an onset near 0.3V on both the PVP55-Pt/C and PVP360-Pt/C in FIGS. 5B and 5C, respectively. The >C═O, however, of PVP360 undergoes an additional stage at ca. 0.8V, which ultimately leads to its readsorption on the surface. The unique interaction between the Pt surface and >C═O leads to additional changes in behavior of CO_{ads} and δ(HOH).

The band areas of FIGS. 5A and 5D lack a coherent pattern between the band areas of δ(HOH) and CO_{L} as the latter was being oxidized from the surface to form CO₂. Nonetheless, water is a critical component to COR and coincidentally in the presence of polymer there were noticeable correlated changes in the δ(HOH) and >C═O bands during the COR. In contrast to the Pt/C, the results for the polymer-modified samples show an increase in the δ(HOH) mode that reached a maximum at ca. 0.8V before decaying to nearly its original surface coverage at high potential. Increased adsorption of water coincided with the CO_{R} and the oxidation-like process of >C═O, which suggests that water was being activated on the surface via interaction with the polymer. Similar trends are noted during the oxidation of methanolic-CO_{L}, most notably the correlation between the uptake of δ(HOH) and >C═O.

The remarkable difference between the PVP55- and PVP360-Pt/C is that the former did not show a readsorption of >C═O at high potential as the enhanced adsorption of water was returning to its original level, but the latter did. The onset potentials of the readsorption of >C═O on the PVP360-Pt/C in FIGS. 5C and 5F coincided with the potentials at which the Stark tuning rate showed a change of value at high potential in FIGS. 4B and 4F, respectively. This observation in FIGS. 4B and 4F provides a rational explanation for the continuous blue-shift in vibrational frequency as the amount of CO_{ads} was decreasing via the COR as the potential increased, which is quite counterintuitive. We believe that the continuous readsorption of >C═O forced the remaining CO_{L} to form rather close packed islands that led to a continuous blue-shift in COL vibration frequency as potential increased.

In summary, the study herein investigated the effect of PVP55 and a heavier chain of PVP360 on Pt/C during the MOR and related gaseous CO oxidations. The electrocatalysts were probed using electrochemical methods to determine the enhanced long-term CO tolerance of the polymer-modified samples and small hindrance to the intrinsic activity of Pt/C. In situ SEIRAS experiments were used to determine the polymer's behavior under the prescribed reaction conditions. We noted the increased adsorption of water in the presence of polymer that coincided with the oxidation of CO_{ads} and was strongly correlated to the desorption of surface-bound >C═O of PVP. This may underline the observed enhanced long-term CO tolerance in MOR since activated water is a critical component of the reaction. The notable differences between the adsorbate trends are indicative of adsorbed polymer interactions with the surface, but more interestingly is the strong dependence of the polymer molecular weight Mw that led to qualitatively different behavior. The fact that the PVP360-Pt/C showed higher CO-tolerance despite having higher CO stripping peak potential may also be indicative of a more enhanced parallel reaction pathway on it. Understanding the effects of adsorbed PVP on electrocatalytic reactions is of both fundamental and practical importance due to its widespread use in syntheses NPs targeted for fuel cell applications. Moreover, the switch-like desorption and re-adsorption of its >C═O moiety observed on the PVP360-Pt/C is an interesting molecular phenomenon that may provide an effective way to stabilize the electrocatalyst at high Pt oxidation potential but free more sites at low potential for fuel oxidation.

What is claimed is:

1. An electrocatalytic composition comprising a platinum-based electrocatalyst and polyvinylpyrrolidone (PVP), wherein the PVP has an average molecular weight of at least about 60,000 g·mol⁻¹ to about 1,600,000 g·mol⁻¹.

2. The composition of claim 1, wherein the platinum-based electrocatalyst is platinum on carbon (Pt/C).

3. The composition of claim 1, wherein the platinum-based electrocatalyst is a platinum-transition metal alloy.

4. The composition of claim 1, 2 or 3, wherein the platinum-based electrocatalyst is in nanoparticulate form with a physical dimension of about 1 nm to about 10 nm.

5. The composition of claim 1, wherein the PVP has an average molecular weight of at least about 160,000 g·mol⁻¹ to about 1,600,000 g·mol⁻¹.

6. The composition of claim 1, wherein the PVP has an average molecular weight of at least about 360,000 g·mol⁻¹ to about 1,600,000 g·mol^{—1}.

7. The composition of claim 1, wherein the PVP has an average molecular weight of about 360,000 g·mol⁻¹.

8. The composition of claim 1, wherein the polymer coverage of PVP on the platinum-based electrocatalyst is about 5-20 wt % PVP/Pt.

9. An electrocatalytic composition comprising a platinum on carbon (Pt/C) electrocatalyst and polyvinylpyrrolidone (PVP), wherein the PVP has an average molecular weight of about 360,000 g·mol⁻¹and surface polymer coverage of the PVP on the Pt/C is about 5-20 wt %.

10. A Direct Methanol Fuel Cell (DMFC) comprising a platinum-based electrocatalyst and polyvinylpyrrolidone (PVP) composition, wherein the PVP has an average molecular weight of at least about 60,000 g·mol⁻¹ to about 1,600,000 g·mol⁻¹.

11. The DMFC of claim 10, wherein the PVP and platinum-based electrocatalyst composition contains between about 5-20 wt % PVP.

12. The DMFC of claim 10, wherein the platinum-based electrocatalyst is Pt/C.

13. The DMFC of claim 10, wherein the platinum-based electrocatalyst is a platinum-transition metal alloy.

14. The DMFC of claim 10, wherein the PVP is desorbed from the surface of the platinum-based electrocatalyst during methanol oxidation at a potential between about 0.0 V-0.80 versus Reversible Hydrogen Electrode (RHE) and wherein the PVP is re-adsorbed onto the surface of the platinum based electrocatalyst at a potential of about 0.80 V-1.60 V versus RHE.

15. The fuel cell of claim 10, wherein the PVP has an average molecular weight of at least about 160,000 g·mol⁻¹.

16. The fuel cell of claim 10, wherein the PVP has an average molecular weight of at least about 360,000 g·mol⁻¹ to about 1,600,000 g·mol⁻¹.

17. The fuel cell of claim 10, wherein the PVP has an average molecular weight of about 360,000 g·mol^{—1}.

18. A method of preventing the oxidation of a platinum-based electrocatalyst, wherein:
a. the platinum-based electrocatalyst is protected with PVP having an average molecular weight of ate least about 60,000 g·mol⁻¹ to about 1,600,000 g·mol⁻¹; and
b. the PVP coverage is about 5-20 wt % of the combined PVP-platinum-based electrocatalyst composition.

19. The method of claim 18 wherein the platinum-based electrocatalyst is platinum on carbon (Pt/C).

20. The method of claim 18, wherein the platinum-based electrocatalyst is a platinum-transition metal alloy.

21. The method of claim 18, wherein the PVP has an average molecular weight of at least about 160,000 g·mol⁻¹ to about 1,600,000 g·mol⁻¹.

22. The method of claim 18, wherein the PVP has an average molecular weight of at least about 360,000 g·mol⁻¹ to about 1,600,000 g·mol⁻¹.

23. The method of claim 18, wherein the PVP has an average molecular weight of about 360,000 g·mol⁻¹.

24. The method of claim 18, wherein the PVP is desorbed from the surface of the platinum-based electrocatalyst during methanol oxidation at a potential between about 0.0 V-0.80 versus Reversible Hydrogen Electrode (RHE) and wherein the PVP is re-adsorbed onto the surface of the platinum based electrocatalyst at a potential of about 0.80 V-1.60 V vs RHE.

25. A method of improving the stability of a platinum-based electrocatalyst, wherein:
a. the platinum-based electrocatalyst is protected with PVP having an average molecular weight of at least about 60,000 g·mol⁻¹ to about 1,600,000 g·mol⁻¹; and
b. the PVP coverage is about 5-20 wt % of the combined PVP-platinum-based electrocatalyst composition.

26. The method of claim 23, wherein the platinum-based electrocatalyst is platinum on carbon (Pt/C).

27. The method of claim 23, wherein the platinum-based electrocatalyst is a platinum-transition metal alloy.

28. The method of claim 23, wherein the PVP has an average molecular weight of at least about 160,000 g·mol⁻¹ to about 1,600,000 g·mol⁻¹.

29. The method of claim 23 wherein the PVP has an average molecular weight of at least about 360,000 g·mol⁻¹ to about 1,600,000 g·mol⁻¹.

30. The method of claim 23 wherein the PVP has an average molecular weight of about 360,000 g·mol⁻¹.

31. The method of claim 23, wherein the PVP is desorbed from the surface of the platinum-based electrocatalyst during methanol oxidation at a potential between about 0.0 V-0.80 versus Reversible Hydrogen Electrode (RHE) and wherein the PVP is re-adsorbed onto the surface of the platinum based electrocatalyst at a potential of about 0.80 V-1.60 V vs RHE.
